(19) United States
(12) Patent Application Publication
(10) Pub. No.: US 2010/0166161 A1
(43) Pub. Date: Jul. 1, 2010

(54) SYSTEM AND METHODS FOR PROVIDING VOICE MESSAGING SERVICES

(76) Inventors: Vishal DHAWAN, Centreville, VA (US); Timothy M. Price, Rockville, MD (US); Manoj Sindhwani, Oak Hill, VA (US)

Correspondence Address: NIXON & VANDERHYE, PC, 901 NORTH GLEBE ROAD, 11TH FLOOR, ARLINGTON, VA, 22203, US

(21) Appl. No.: 12/717,881

(22) Filed: Mar. 4, 2010

Related U.S. Application Data
(63) Continuation-in-part of application No. 11/514,116, filed on Sep. 1, 2006.
(60) Provisional application No. 60/712,808, filed on Sep. 1, 2005.
(60) Provisional application No. 61/157,320, filed on Mar. 4, 2009.
(60) Provisional application No. 61/157,324, filed on Mar. 4, 2009.

(51) Int. Cl. H04M 1/64

(52) U.S. Cl. 379/88.19

(57) ABSTRACT

A voicemail system is capable of recording multiple personalized voicemail greetings for multiple individual potential calling parties. When a call is received by the voicemail system, the identity of the calling party is determined. This can be accomplished through caller ID information for the incoming call, or by interpreting spoken input provided by the calling party. If a personalized voicemail greeting has been established for the calling party, then the personalized voicemail greeting is played to the calling party. If no personalized voicemail greeting has been established for the calling party, a generic voicemail greeting is played to the calling party.

This application claims priority to the filing date of U.S. Provisional Application No. 61/157,320 and U.S. Provisional Application No. 61/157,324, which were both filed on Mar. 4, 2009, the contents of both of which are hereby incorporated by reference. This application is also a continuation-in-part of U.S. application Ser. No. 11/514,116, which was filed on Sep. 1, 2006, which itself claims priority to the filing date of U.S. Provisional Application No. 60/712,808, which was filed on Sep. 1, 2005, the contents of both of which are hereby incorporated by reference.

### FIELD OF THE INVENTION

The invention relates to systems and methods for providing a user with voicemail voice messaging services.

### BACKGROUND OF THE INVENTION

There are presently many different types of voicemail systems being used to record messages from callers when someone is unable or unwilling to answer an incoming telephone call. FIG. 1 presents some of the most commonly used options.

In some instances, a user telephone 10, which is connected to the telephone network 230, is also connected to a voicemail recording device 12. The voicemail recording device monitors the ringing of the user telephone 10 when an incoming call is received. If the user does not answer a call after a certain number of rings, the voicemail recording device will answer the call. Typically the voicemail recording device 12 will play a pre-recorded greeting that invites the caller to leave a message, and then the device will record any message that the caller wishes to leave. The call will end when the caller hangs up. Or, if the caller does not hang up the line, the voicemail recording device 12 will terminate the call if it detects a period of silence lasting more than a predetermined period of time.

Some voicemail recording devices 12 are equipped with a speaker, and the devices are capable of playing the outgoing message and/or the message being recorded as a caller leaves the message. Thus, if the user is present near the voicemail recording device 12, and the user deliberately fails to answer the call, the voicemail recording device 12 will pick up the call, and the user can listen as the caller leaves a message. If the user decides that he would prefer to talk to the caller, the user may be able to pickup his telephone and begin speaking to the caller. This strategy can be employed by the user if the user is uncertain about the identity of the caller, or the caller's purpose.

Of course, this type of a voicemail recording device 12 will also allow a user to playback recorded messages, and save or delete individual recorded messages.

Another common voicemail service is provided by telephone service providers. In this instance, the telephone service providers will maintain telephone system voicemail units 232 which are also connected to the telephone network 230. These services allow the users to record one or more greeting messages that will be played to callers if the user is unable or unwilling to answer a call. These services also record messages that are left by callers, and allow the users to retrieve and play message that have been left by callers.

With this sort of a system, if an incoming call directed to a user telephone 10 or a user mobile telephone 14 is not answered after a certain number of rings, the telephone network 230 will connect the call to the telephone system voicemail unit 232. The telephone system voicemail unit will play a pre-recorded message that has been stored for the user, and then record any message that the caller wishes to leave. As with the voicemail recording device 12 discussed above, a call will end when the caller hangs up, or when the telephone system voicemail unit 232 detects a period of silence that lasts longer than a predetermined period of time.

The user will be able to access and play the voicemail messages left by callers. Typically, the user will need to place a telephone call to connect to the telephone system voicemail unit 232 in order to play back recorded voicemail messages. This means that the user can retrieve his voice messages from any location. However, with this sort of a voicemail service, the user is unable to monitor a message as it is being recorded.

Another type of common voicemail system is used with private branch exchanges (PBXs), which are often used by small to medium sized businesses. As illustrated in FIG. 1, a PBX 30 could interface with a telephone network to connect a business to the telephone network 230. The PBX would route direct dialed telephone calls to individual telephones 32, 33, 34. A central operator would also be able to answer a direct or main line into the business, and then connect the call individual ones of the telephones 32, 33, 34.

A voicemail system 36 would be connected to the PBX. The voicemail system 36 would act to record messages from callers when a user fails to answer an incoming call routed to one of the telephones 32, 33, 34. This could occur during a direct inward dialed call, or when a receptionist connects a call to one of the telephones, and that user fails to answer the call.

Similar to the telephone system voicemail unit discussed above, the voicemail system 36 connected to a PBX 30 would allow users to record greeting messages, and the voicemail system would allow users to access and play voicemail messages left by callers. A user could access the voicemail system from one of the telephones 32, 33, 34 connected to the PBX 30, or possibly by calling into the business from an outside telephone. Here again, the users would be unable to monitor a call as a caller is leaving a voicemail message.

The PBX system has one advantage that is not enjoyed by the other voicemail systems described above. With a PBX system, if a call is received on a main line into the business, the receptionist can answer the call and determine who the caller is attempting to reach. The receptionist can then check to see if the called party is available to take the call. Typically, this is done by placing an internal call from the receptionist to the called party while the caller is waiting on hold. If the called party is unavailable or unwilling to take the call, the receptionist can route the call to the voicemail system so that the caller can leave a message. Thus, with a PBX system, it is possible to answer an incoming call, but still have the caller leave a voicemail message in the voicemail system. Of course, operating in this fashion requires a live operator.

In the situation where a voicemail recording device 12 is directly coupled to a user's telephone 10, it is not possible for the user to answer an incoming call, and then still allow the caller to leave a message on the voicemail recording device 12. Once the call has been answered, the only option is to terminate the call. Likewise, if a user has a third party voicemail service, such as those provided by telephone carriers, it is also impossible to answer a call, and then route the caller to the voicemail service so that the caller can leave a voicemail message.

The fact that it is often impossible to route a call to a voicemail system after the call has been answered can be inconvenient when multiple parties share access to a single telephone. For instance, when a call is received at a home, and the caller wants to talk to an unavailable family member, it is impossible for the family member that answered the call to route the caller into a voicemail system so that the caller can leave a message for the unavailable family member.

In addition, with many voicemail systems, there is only a single voice mailbox which can store voicemail messages. If there are multiple family members, one would like for each family member to have their own individual mailbox so that voicemail messages can be directed to the proper party.

There are various existing computer and telephony systems that provide voice services to users. These voice services can be speech recognition and touchtone enabled. Examples of such services include voice mail, voice activated dialing, customer care services, and the provision of access to Internet content via telephone.

One common example of a system that provides voice services is an Interactive Voice Response (IVR) system. In prior art systems, a user would typically use a telephone to call in to a central computer system which provides voice services via an IVR system. The IVR system deployed on the central computer system would then launch voice services, for instance by playing an audio clip containing a menu of choices to the user via the telephone line connection. The user could then make a selection by speaking a response. The spoken response would be received at the central computer system via the telephone line connection, and the central computer system would interpret the spoken response using speech recognition techniques. Based on the user's response, the IVR system would then continue to perform application logic to take further action. The further action could involve playing another menu of choices to the user over the telephone line, obtaining and playing information to the user, connecting the user to a third party or a live operator, or any of a wide range of other actions.

The ability to provide voice services has been quite limited by the nature of the systems that provide such services. In the known systems that provide voice services using relatively complex speech recognition processing, the voice applications are performed on high end computing devices located at a central location. Voice Application processing requires a high end centralized computer system because these systems are provisioned to support many simultaneous users.

Because complex voice application processing must be provided using a high end computer system at a central location, and because users are almost never co-located with the high end computer system, a user is almost always connected to the central computer system via a telephone call. The call could be made using a typical telephone or cell phone over the PSTN, or the call might be placed via a VoIP-type (Skype, SIP) connection. Regardless, the user must establish a dedicated, persistent voice connection to the central computer system to access the voice services.

In a typical prior art architecture for a centralized voice services platform, the speech recognition functions are performed at a central computer system. A user telephone is used to place a telephone call to a central voice services platform via a telephone network. The telephone network could be a traditional PSTN, or a VoIP based system. Either way, the user would have to establish the telephone call to the central voice service platform via a telephone carrier.

The prior art centralized voice services platforms, which depend on a telephony infrastructure for connection to users, are highly inflexible from a deployment standpoint. The configurations of hardware and software are all concentrated on a small number of high end servers. These configurations are technically complex and hard to monitor, manage, and change as business conditions dictate. Furthermore, the deployment of existing IVR system architectures, and the subsequent provisioning of users and voice applications to them, requires extensive configuration management that is often performed manually. Also, changes in the configuration or deployment of IVR services within extant IVR architectures often require a full or partial suspension of service during any reconfiguration or deployment effort.

Further, cost structures and provisioning algorithms that provision the capabilities of such a centralized voice services platform make it virtually impossible to ensure that a caller can always access the system when the system is under heavy usage. If the system were configured with such a large number of telephone line ports that all potential callers would always be connected to access contrasting types of voice services, with different and overlapping peak utilization hours, the cost of maintaining all the hardware and software elements would be prohibitive. Instead, such centralized voice services platforms are configured with a reasonable number of telephone ports that result in a cost-effective operating structure. The operator of the system must accept that callers may sometimes be refused access. Also, system users must accept that they will not receive an “always on” service.

Prior art centralized voice services platforms also tend to be “operator-centric.” In other words, multiple different service providers provide call-in voice services platforms, but each service provider usually maintains their own separate platform. If the user has called in to a first company's voice services platform, he would be unable to access the voice services of a second company's platform. In order to access the second company's voice services platform, the user must terminate his call to the first company, and then place a new call to the second company's platform. Thus, obtaining access to multiple different IVR systems offered by different companies is not convenient.

In addition to the above-described drawbacks of the current architecture, the shared nature of the servers in a centralized voice services platform limits the ability of the system to provide personalized voice applications to individual users. Similarly, the architecture of prior art IVR systems limit personalization even for groups of users. Because of these factors, the prior art systems have limitations on their ability to dynamically account for individual user preferences or dynamically personalize actual voice applications on the fly. This is so because it becomes very hard for a centralized system to correlate the user with their access devices and environment, to thereby optimize a voice application that is tuned specifically for an individual user. Further, most centralized systems simply lack user-specific data.

With the prior art voice services platforms, it was difficult to develop efficient mechanisms for billing the users. Typically, the telephone carrier employed by the user would bill the user for calls made to the voice services platform. The amount of the charges could be determined in many different ways. For instance, the telephone carrier could simply bill the user a flat rate for each call to the voice services platform. Alternatively, the telephone carrier could bill the user a per-minute charge for being connected to the voice services platform. In still other methods, the voice services platform could calculate user charges and then inform the carrier about how much to bill the user. Regardless of how the charges are calculated, it would still be necessary for the telephony carrier to perform the billing, collect the money, and then pay some amount to the voice service platform.

Prior art voice services platforms also had security issues. In many instances, it was difficult to verify the identity of a caller. If the voice services platform was configured to give the user confidential information, or the ability to transfer or spend money, security becomes an important consideration.

Typically, when a call is received at the voice services platform, the only information the voice services platform has about the call is a caller ID number. Unfortunately, the caller ID number can be falsified. Thus, even that small amount of information could not be used as a reliable means of identifying the caller. For these reasons, callers attempting to access sensitive information or services were usually asked to provide identifying data that could be compared to a database of security information. While this helps, it still does not guarantee that the caller is the intended user, since the identifying data could be provided by anybody.

Some prior art voice services platforms were used to send audio messages to users via their telephones. The central voice services platform would have a pre-recorded audio message that needed to be played to multiple users. The platform would call each of the users, and once connected to a user, would play the audio message. However, when it was necessary to contact large numbers of users, it could take a considerable amount of time to place all the calls. The number of simultaneous calls that can be placed by the centralized voice services platform is obviously limited by the number telephone ports it has. Further, in some instances, the PSTN was incapable of simultaneously connecting calls on all the available line ports connected to the voice services platform. In other words, the operators found that when they were trying to make a large number of outgoing calls on substantially all of their outgoing lines, the PSTN sometimes could not simultaneously connect all of the calls to the called parties. Further, when a voice services platform is delivering audio messages in this fashion, they tie up all the telephone port capacity, which prevents users from calling in to use the service.

### BRIEF DESCRIPTION OF THE DRAWINGS

FIG. 1 illustrates various background art devices that are used to provide voice mail functions to a user;

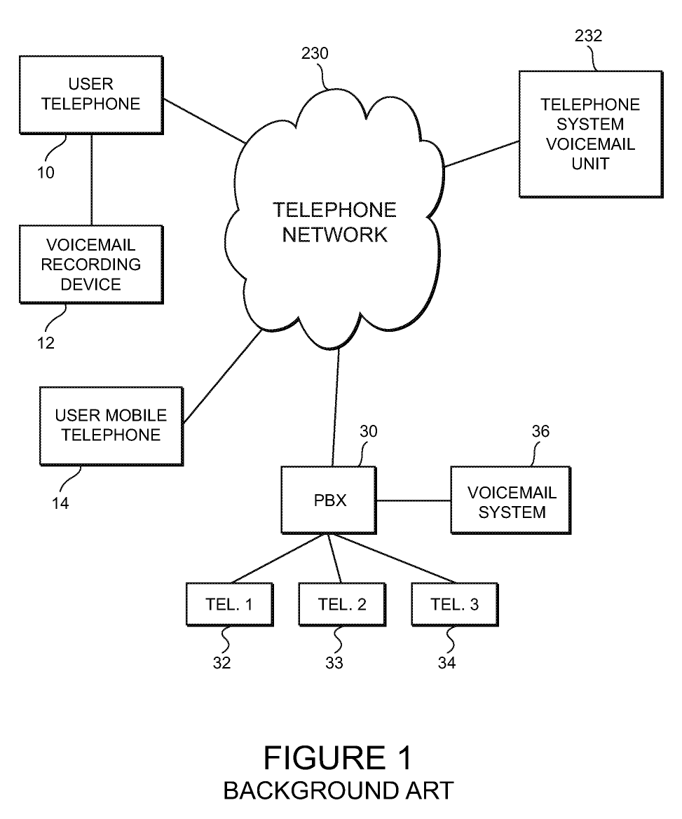

FIG. 2 illustrates elements of a system embodying the invention;

FIG. 3 illustrates elements of another system embodying the invention;

FIG. 4 illustrates elements of another system embodying the invention;

FIG. 5 illustrates elements of a remote voicemail service embodying the invention;

FIG. 6 illustrates steps of a method of providing a user with voicemail services;

FIG. 7 illustrates steps of a method for allowing a user to record a personalized voicemail greeting that will be played to callers;

FIG. 8 illustrates another embodiment of a remote voicemail service embodying the invention;

FIG. 9 illustrates steps of a method of routing a caller into an appropriate voice mailbox; and

FIG. 10 illustrates steps of another method of routing a caller into an appropriate voice mailbox.

### DETAILED DESCRIPTION OF PREFERRED EMBODIMENTS

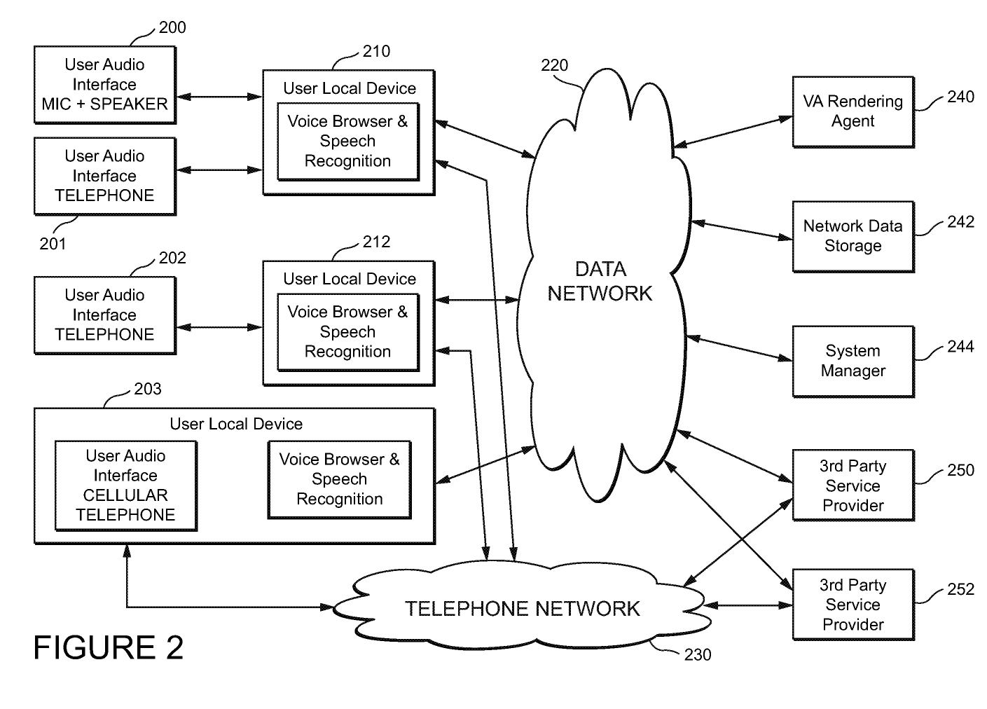

The inventors have developed new systems and methods of delivering voice-based services to users which make use of some aspects of the basic architecture illustrated in FIG. 2. A full description of the systems and methods created by the inventors is provided in U.S. patent application Ser. No. 11/514,116, which was filed on Sep. 1, 2006.

The systems and methods created by the inventors are intended to provide users with speech and touch tone enabled Voice Applications for accessing various services and for performing various functions. In this respect, the systems, devices and methods embodying the invention serve some of the same functions as prior art centralized voice services platforms. The systems and methods can also be used to provide the same type of call forwarding discussed above, but at a lower cost, and with greater flexibility. In addition, the systems and methods created by the inventors make it possible to provide users with a whole host of additional call handling and call notification functions that would have been impossible with prior systems.

Unlike the prior art voice services platforms, systems and methods embodying the invention utilize a highly distributed processing architecture to deliver the services. As will be explained below, the underlying architecture and the distributed nature of systems and methods embodying the invention allow the inventive systems to provide the same services as the prior art systems, but with better performance, at a significantly reduced cost, and with far fewer limitations. In addition, systems and methods embodying the invention avoid or solve many of the drawbacks of the prior systems. Further, because of the way systems and methods embodying the invention operate, they can provide new and additional services that could never have been provided by the prior art systems. Systems and methods embodying the invention also allow for much better personalization of delivered services, and they allow existing services to be upgraded, improved, or further personalized much more easily than was possible with the prior art systems.

Systems and methods embodying the invention are intended to deliver or provide Voice Applications (hereinafter, “VAs”) for a user. Before beginning a discussion of systems and methods that embody the invention, we should start by discussing what a VA is, and what a VA can do for a user. Unfortunately, this is somewhat difficult, because VAs can take a wide variety of different forms, and can accomplish a wide variety of different tasks.

A VA provides a user with the ability to use their natural voice, touch tone sequences or other forms of user input, to access and/or control an application, to obtain information, to perform a certain function, or to accomplish other tasks. Although the majority of the following description assumes that a user will interact with a system embodying the invention, at least in part, via speech, other forms of user interaction fall within the scope and spirit of the invention. For instance, developing technologies that allow a user to make selections from visual menus via hand or eye movements could also for the basis of a user interaction protocol. Likewise, developing technologies that are able to sense a user's brainwave patterns could form the basis of a user interaction protocol. Thus, systems and methods embodying the invention are not limited to speech-based user interfaces.

A VA could be specifically developed to utilize the benefits of speech recognition-based input processing. For instance, a VA could be developed to access, play and manipulate voice mail via speech commands. Alternatively, a VA could act as an extension or an enhancement of traditional GUI-like applications to allow the traditional applications to be accessed and/or controlled by speech commands. For instance, a VA could allow the user to call up specific e-mail messages on a display via spoken commands, and the user would then read the e-mail messages on the display.

In some instances, a VA could act like one of the interactive voice response systems that are accessible to users on prior art centralized voice services platforms. A VA could act in exactly the same way as a prior art IVR system to allow a user to obtain information or accomplish various functions using a speech enabled interface. However, because of the advantages of the new architecture, a system embodying the invention can perform voice applications that would have been impossible to perform on prior art centralized voice services platforms. Other VAs could perform a wide variety of other tasks. In most instances, the user would be able to accomplish functions or obtain information by simply speaking voice commands.

With the above general description of a Voice Application (VA) as background, we will now provide an overview of systems and methods embodying the invention. The following overview will make reference to FIG. 2, which depicts a high-level diagram of how a system embodying the invention would be organized.

As shown in FIG. 2, preferred embodiments of the invention would make use of an optional telephone network 230 and a data network 220. The telephone network 230 could be a traditional PSTN, a VoIP system, a peer-to-peer telephone network, a cellular telephone network, or any other network that allows a user to place and receive telephone calls. The data network 220 could be the Internet, or possibly a private or internal local area network or intranet.

In some instances, users would only be physically coupled to a data network, such as the Internet. In this case, the user's on-site equipment could enable them to place VoIP telephone calls via the data network. Such VoIP telephone calls might make use of the PSTN, or the entire call might be handled over the data network. Regardless, in preferred embodiments, the user would be capable of simultaneously maintaining a telephone connection and sending and receiving data.

Systems embodying the invention, as shown in FIG. 2, will be referred to as having a Distributed Voice Application Execution System Architecture (hereinafter, a “DVAESA”). Thus, the term DVAESA refers to a system and method of providing voice application services in a distributed fashion, over a network, to a customer device. Such a system is closely managed by a centralized system to, among other things, ensure optimum performance, availability and usability. In some of the descriptions which follow, there are references to “DVAES-enabled” equipment or local devices/device. This means equipment and/or software which is configured to act as a component of a DVAESA embodying the invention.

A user would utilize an audio interface device to access the DVEASA. In the embodiment shown in FIG. 2, a first user's audio interface 200 comprises a microphone and speaker. A second user audio interface 201 comprises a telephone. The telephone 201 is also connected to the same user local device 210 as the first user audio interface. A third user's audio interface 202 could also comprise a telephone. This telephone 202 could be a regular wired telephone, a wireless telephone or even a cellular telephone. The DVAES-enabled devices may support multiple audio interface devices, and the multiple devices could all be of the same type, or multiple different types of user audio interfaces could all be connected to the same local device.

Each user would also make use of a local DVAES-enabled device that would act to deliver or provide VAs to the user through the user's audio interface. The local DVAES-enabled devices would include a voice browser capable of performing voice applications that have been distributed over the network, some of which may have speech recognition functions. Such voice applications could be pre-delivered to the local DVAES-enabled device, or the voice applications could be fetched in real time. Such voice applications are personalized to the user and optimized for the device. In the embodiment shown in FIG. 2, each of the user local devices 210, 212, 203 are coupled to the respective user audio interfaces, and to the data network.

In some embodiments of the invention, a user audio device and a DVAES-enabled device could be integrated into a single electronic device. For instance, a PDA with cell phone capability could also incorporate all of the hardware and software elements necessary for the device to also act as the DVAES-enabled equipment. Thus, a single user device could function as both the DVAES-enabled equipment that communicates with the network, and as the user audio interface. The user local device 203 shown in FIG. 2 is intended to illustrate this sort of an embodiment.

Also, in FIG. 2, various lines connect each of the individual elements. These lines are only intended to represent a functional connection between the two devices. These lines could represent hard-wired connections, wireless connections, infrared communications, or any other communications medium that allows the devices to interact. In some instances the connections could be continuous, and in others the connection could be intermittent. For instance, an audio interface and a user local device could be located within a user's vehicle. In such a case, the local device within the vehicle might only be connected to the network through a cellular telephone network or through another type of wireless network when such connectivity is required to provide a user with services. In a similar embodiment, the local device in the user's vehicle might only link up to the network when the vehicle is parked at the user's home, or some other location, where a wireless connection can be implemented.

Also, the user audio interface 202 shown in FIG. 2 could be a cell phone that is capable of interacting with the normal cellular telephone network. However, the cellular telephone might also be capable of interacting with the user local device 212 via a wired or wireless connection. Further, the cellular telephone 202 might be configured such that it acts like a regular cellular telephone when the user is away from home (and is not connected to the local device 212). But the cellular telephone might switch to a different operating mode when it is connected to the local device 212 (when the user is at home), such that all incoming calls to that cell phone are initially received and processed by the local device 212. The DVAESA also would include some network-based elements. As shown in FIG. 2, the network-based elements could include a VA rendering agent 240, a network storage device 242 and a system manager 244. Each of these network-based elements would be connected to the data network.

Also, although they would not technically be considered a part of the DVAESA, there might also be some third party service providers 250, 252 which are also connected to the data network, and/or to the telephone network. As explained below, the VAs may enable the users to interact with such third party service providers via the data and telephone networks.

When a DVAESA as shown in FIG. 2 is configured, VAs would be “rendered” by the VA rendering agent 240, the output of the rendering process would be rendered VAs. These rendered VAs may be stored on the Network Storage Device 242, or be distributed or delivered to a DVAES-enabled Device. “Rendering” refers to a process in which a generic VA is personalized for a particular user and/or one or more particular DVAES-Devices to generate Rendered VAs. The system manager 244 could instruct the VA rendering agent 240 to render a VA for a particular user, or such rendering request could originate from the DVAES-enabled Device. The DVAESA network data storage element 242 could be used to store generic VA, rendered VAs, or a wide variety of other data and resources (e.g. audio files, grammars etc).

As mentioned above, the VA rendering agent would personalize a generic VA during the rendering process. This could take into account personal traits of the individual user, information about the configuration of the local device(s), or a wide variety of other things, as will be explained in more detail below. The information used to personalize a VA during the rendering process could be provided to the VA rendering agent at the time it is instructed to render the VA, or the VA rendering agent could access the information from various data storage locations available via the data network.

The user's local devices would typically be inexpensive computing devices that are capable of running a voice browser and performing speech recognition capable rendered VAs. Such devices are often referred to as embedded multimedia terminal adaptors (EMTAs) and optical embedded multimedia terminal adaptors (OEMTAs). In many instances, the local device would be physically present at the user's location, such as a home or office. In other instances, however, the local device could be a virtual device that is capable of interacting with one or more user audio interfaces. As mentioned above, the local devices may also store rendered VAs, and then act to perform the rendered VAs to the user's audio interface. The user local device could be a customer premise device that is also used for some other function. For instance, the local device could be a cable modem or set-top box that is also used to connect a television to a cable network, however, the device would also be configured to perform VAs for the user via the user's audio interface.

In one simple embodiment of the invention, a local embedded device 212 would be linked to a user's telephone 202. The local device 212 would also be linked to the Internet 220 via a medium to high speed connection, and possibly to the telephone network 230. The user could speak commands into the telephone 202, and those spoken commands would be processed by the local device 212 to determine what the user is requesting.

The processing and interpretation of a user's spoken commands could be entirely accomplished on the local device 212. In other embodiments, the local device might need to consult a speech recognition engine on a remote device, via the data network, to properly interpret a portion of a spoken command that cannot be understood or interpreted by the local device. In still other embodiments, the user's spoken commands could be entirely processed and interpreted by a remote speech recognition engine. For instance, a recording of the user's spoken commands could be relayed to a remote speech recognition engine, and the speech recognition engine would then process the spoken commands and send data back the local device indicating what the user is commanding. Even this process could be accomplished in real time such that the user is unaware that the interpretation of his spoken commands is being accomplished on a remote device.

Because of the greater sophistication that is possible with a system embodying the invention, if the local device does not understand something, it can often ask another question of the user to clarify the situation. In addition, the local device can offer greatly expanded vocabulary and speech processing by enlisting the assistance of network agents. For all these reasons, a consumer electronic device that is coupled into the DVAES architecture can provide a much more sophisticated voice application than prior art devices which were not connected to a network.

Once the spoken command has been interpreted, in some instances, the local device 212 may be able to satisfy the user's request. In other instances, the local device 212 might need to request information from a VA Rendering Agent 240 to satisfy the user's request. If that is the case, the local device 212 would send a query over the data network 220 to the VA Rendering Agent 240 for some type of content. The requested content would be returned to the local device 212, and the local device 212 would then provide the content to the user via the user's telephone 202. In other instances, the local device may be able to query other network-connected elements which are not a part of the DVAES Architecture, and those other elements would return the requested data to the local device so that the data could be delivered to the user via the audio interface.

Depending on the VA being performed, the functions that are performed in response to a user request may not involve playing audio information to the user via the user's audio interface. For instance, the local device could be performing a VA relating to accessing e-mail. In this instance, a user's spoken request could cause the local device to act in a manner that ultimately results in the user's e-mail messages being shown on a display screen. In this instance, although the user makes use of a speech-based interface to obtain information and/or perform a certain function, the ultimate result is not the playback of audio, but rather display of an e-mail message.

The end result of a user request could take many other forms, such as the local device causing a certain action to be taken. For instance, the user might speak a request that causes the user's home air conditioning system to be turned on. The list of possible actions that could be enabled by the local device is virtually endless. But the point is that the local device is able to provide a speech-enabled interface to the user, via the audio interface, to allow the user to accomplish a task.

In another simple embodiment, the user might pick up his telephone 202 and speak a request to be connected to another person's telephone. A voice application performed on the local device would interpret the user's spoken request. This could be done on the local device, or the voice application could utilize remote assets to accomplish the speech recognition. Some or all of the speech recognition could occur on the remote assets. The voice application would then take steps to place a telephone call to the person identified by the user. This might involve connecting the user via the telephone network 230, or connecting the user to the requested party via a VoIP call placed over the data network 220.

It is also worth noting that when a user is connected to the DVAES architecture, the VAs provided by the system can completely replace the dial tone that people have come to associate with their telephones. The moment that a user picks up his telephone, he will be launched directly into a voice application that is provided by the system. In the past, this may have been technically possible, but it was always accomplished by making use of the traditional phone system. For instance, one of the prior art centralized voice services platforms would have been capable of ensuring that the moment a user lifts his telephone, that user was immediately connected to a central voice services platform that would guide the remainder of the user's experience. But this was always accomplished by establishing an immediate voice channel between the user's telephone and the central voice services platform. And to accomplish that, it was necessary to involve the telephone carrier that would link the user's telephone to the voice services platform. In contrast, with the DVAES architecture, one no longer needs to make any use of the telephone carriers to provide this sort of a service. And, as noted above, the user can still be easily connected to the regular telephone network if he needs to place a call.

In the same vein, in the past, whenever a user wanted to have a third party service answer his telephone calls, as in traditional voice mail systems, it was necessary to involve the carrier in routing such calls to a third party service. Now, when a call is made to the user's telephone, the DVAES architecture makes it possible to answer the call, and take voice mail recordings, without any further involvement of the carrier. Here again, the DVAES architecture makes it possible to eliminate the services of the telephone carrier.

In both the examples outlined above, the involvement of the carrier necessarily increased the cost of providing the voice services. Because the carrier can be eliminated, the same sorts of voice services can be provided to a user for a significantly reduced cost. And, as explained below, the services can be delivered with greater performance and with new and better features.

In some embodiments, rendered Voice Application processing is performed on the local device and the associated the voice recognition functions may also be performed on the local device. For this reason, there is no need to establish a dedicated duplex audio link with a remote high end computer. Also, even in those instances where a portion of the voice application processing is performed by a remote device, and/or where processing and interpretation of spoken commands is processed by a remote device, the communications necessary to accomplish these actions can be made via data packets that traverse a data network. Thus, here again, there is no need to establish a dedicated duplex audio link with a remote high end computer to provide the requested services.

Also, because the local embedded device is coupled to a data network such as the Internet, it can rapidly obtain Rendered Voice Applications and associated data from various remote sources in order to satisfy user requests. For these reasons, the simple embedded local device allows one to provide the user with speech recognition enabled Voice Applications without the need to create and maintain a high end speech service platform with multiple telephone line access equipment.

As noted above, the local device could also use the network to obtain access to various other physical elements to effect certain physical actions, such as with the home air conditioner example given above. In this context, the other physical elements could be connected to the network, or the local device could have a local connection to physical elements that are also located on the user's premises. For instance, the local device could have a hard-wired or wireless connection to many different elements in a user's home or office that allow the local device to control operations of the physical elements. In other embodiments, the piece of physical equipment could act as the local device itself.

One obvious advantage of a DVAESA over prior art voice service platforms is that a DVAESA embodying the invention can provide VAs to users without any involvement of a PSTN, VoIP, Peer-Peer carrier. The instant the user picks up his telephone handset, he will be interacting with the DVAESA, not the telephone system. A large number of VAs could be accomplished without ever involving a telephone carrier as the Voice Application is delivered and provided on the local device. Because the user can directly access the DVAESA without making a telephone call, the operator of the DVAESA will not need to pay a telephone carrier in order to provide the service to users.

As noted above, if the user wishes to place a telephone call, this can be easily accomplished. But there is no need to use a telephone carrier as an intermediary between the user and the DVAESA. This has multiple positive benefits.

Also, for a multitude of different reasons, a DVAESA will be less expensive to deploy and operate than the prior art central voice services platforms. To begin with, because the DVAESA can provide services to users without a telephone link, the DVEASA operator no longer need to purchase and maintain multiple telephone line ports into the system.

Also, the types of equipment used by the DVAESA are inherently less expensive to deploy and manage than the equipment used in a central voice services platform. A DVAESA embodying the invention uses relatively inexpensive network appliances that can be located anywhere, and that can be deliberately distributed over a wide area to enhance reliability of the system. In contrast, a central voice services platform requires expensive and specialized telecom equipment like telecom switches and IVR servers. The central voice services platforms also require more intensive management and provisioning than a DVAESA, and this management must be provided by highly skilled personnel as most of the equipment used is highly proprietary in nature. In contrast, the DVAESA is largely managed by an automated management system.

A prior art central voice services platform is only able to simultaneously service a limited number of users As noted above, in the prior art central voice services platforms, a dedicated voice link, via a telephone call, is maintained for each connected user. Once all lines are connected to users, no additional users are able to access the system. Hence the maximum number of simultaneous users that can be supported at any given time is equal to the lesser of the number of access lines or the number of associated telephony/IVR ports an operator maintains.

In contrast, a DVAESA embodying the invention has a very high limit on the number of users that can be simultaneously serviced. In a DVAESA embodying the invention, the moment a customer picks up his telephone he will be connected to the system. Thus, a DVAESA embodying the invention is “always on.” Also, much of the interactions between the user and the system are handled directly by the local device on the customer premises. If the local device cannot immediately service a user request, and additional information is needed, the local device may make a synchronous or asynchronous request over the Internet. Typically, the information will be quite rapidly returned and played to the user. Thus, even if there is a small delay, the user is nevertheless still connected the voice services system.

With the DVAESA model, the same number of server assets can handle data requests from a much larger number of users as compared to the prior art central voice services platform. This is also another reason why a DVAESA is less expensive to deploy and maintain than a prior art central voice services platform.

In addition to being easier and less expensive to deploy and maintain, a DVAESA embodying the invention can also scale up much more quickly and at a lower cost as new users are added to the system. To begin with, because the DVAESA does not require dedicated telephone lines to operate, there is no cost associated with adding additional telephone ports to the system to accommodate additional users. Likewise, as new users are added, there are no new additional telecommunications expenses for more connect time or access. In addition, for the reasons noted above, the equipment used by the system is far less expensive than the equipment used in a central voice services platform to service the same number of users. Thus, adding any new equipment and users is less expensive for a DVAESA. Moreover, because it requires less equipment to service the same number of users in a DVAESA, there is much less equipment to purchase and maintain for each additional 1000 users.

A DVAESA embodying the invention is inherently more reliable than a prior art central voice services platform. Because the assets of a prior art system are typically located in a few physical locations, and are tied to physical phone lines, power outages and other physical problems are more likely to prevent users from being able to use the system. In contrast, a DVAESA can have its equipment distributed over a much wider area to reduce these problems. The points of a failure of a DVAESA can be highly localized and it is very cost effective to replicate DVAESA equipment.

Moreover, the underlying nature of the DVAESA makes it easy to connect multiple redundant servers to the network, so than in the event one or more assets fail, redundant assets can step in to take over the functions of the failed equipment. This was difficult to do in prior art central voice services platforms, and even when it was possible to provide redundant capabilities, the cost of providing the redundant equipment was much higher than with a DVAESA.

In addition, a prior art central voice service platform needs a telephone carrier to provide access to the users. If the telephone carrier has a service outage, the prior art system cannot function. In contrast, a DVAESA does not have any reliance on a telephone carrier.

The only network required to provide the DVAESA is the data network like the Internet. The user in most cases will not experience an interruption to access to the voice services of a DVAESA, even if there is an outage that disables the local device's access to the Internet. The local device could potentially perform some of the applications without connecting to the network. This indicates that for some Voice Applications in the DVAESA, it may be sufficient for the local device to have intermittent access to the Internet.

The architecture of a DVAESA makes it inherently able to deliver certain types of VAs with vastly improved performance. To use one concrete example, as noted above, when a central voice services application is attempting to deliver the same audio message to large number of users, the central voice services application must place a telephone call to each user, using a dedicated phone line, and deliver the message. Because the central voice services platform only has a limited number of outgoing lines, it can take a significant amount of time to place all those calls.

In contrast, in a DVAESA embodying the invention, it is not necessary to place any telephone calls to deliver the audio message to users. Instead, a server which is part of the system can push instructions to play the audio message, and the message itself (the message could be stored in advance of when the event to deliver the message occurs), to each of the local devices, and the local devices can then play the messages for each individual user. In variations on this theme, the server might only send the instruction to play the message, along with a reference to where a copy of the audio message is stored. Each local device could then download a copy of the message from the indicated location and play it for the user. Regardless, it would be possible for the DVAESA architecture to deliver the audio message to all the users in a small fraction of the time that it would take the prior art central voice services platform to accomplish the job.

Moreover, as also explained above, while the prior art central voice services platform is making calls to deliver audio messages to a plurality of users, it is tying up it's phone lines, and thus it's capacity to allow users to call in for services. In contrast, when a DVAESA is delivering audio messages to a plurality of users, the users are still able to access their voice services for other purposes.

A DVAESA embodying the invention also makes it possible to deliver many new voice applications and services that could never have been provided by the prior art central voice services platform. In most cases, it is the underlying differences in the architecture of a DVAESA embodying the invention, as compared to the prior art voice services platforms, which make these new services possible.

For example, a user could configure a voice application to run constantly in the background on a local device, and then take a certain action upon the occurrence of a specified event. So, for instance, the user could set up a voice application to break into an existing telephone conversation to notify him if a particular stock's trading price crosses a threshold. In this scenario, the voice application would periodically check the stock price. If the threshold is crossed, the voice application could cause any existing telephone call that the user is on to be temporarily suspended, and the voice application would then play the notification. The voice application could then return the caller to his call. This sort of a voice application would also be very complicated to provide under the prior art central voice services platform.

The graceful integration of advertising messages is another example of how a DVAESA embodying the invention can provide services that were impossible to provide with prior art central voice service platforms. As an example, if the user lifted the telephone and spoke a command that asked for options about ordering a pizza, the system could respond with a prompt that said, “to be connected to Pizza Shop A, say one; to be connected to Pizza Shop B, say two. By the way, Pizza Shop A is having a two for one special today.” Thus, the advertising message could be gracefully incorporated into the played response. Also, the advertising message would be highly context relevant, which would make it more interesting to advertisers. Thus, advertising revenue could be collected by the operator of the DVAESA system.

A DVAESA embodying the invention could also be used to rapidly collect data from a very large number of users in ways that would have been impossible with prior art central voice services platforms. In this example, assume that a television program is currently airing, and during the program, viewers are invited to vote on a particular issue. In prior art systems, the users would typically place a telephone call to a central voice services platform and make a voice vote. However, as noted earlier, prior art voice services platforms are only able to talk to a limited number of callers at the same time because the callers must be connected by dedicated phone lines.

In a DVAESA embodying the invention, the user might be able to pick up the phone and say, “I want to vote on issue X.” The system would already know that viewers of a television program had been invited to place a vote, so the system could immediately take the user's voice vote. The system could also tabulate the votes from all users making similar voice votes, and then provide the voting results to the television show producers in real time. Because so little actual information is being exchanged, and the exchanges are made over the Internet, thousands, and perhaps even millions of votes could be received and tabulated in a very short period of time. This would have been impossible with prior art central voice services platforms. Furthermore, a DVAES can distribute a fully featured voice application that not only plays the message, but further solicits feedback from the user, optionally tailors the interaction with the user, and may record any user feedback or responses. Furthermore, if the producers of the television show were willing to pay a fee to the operator of the DVAESA, the system could be configured such that as soon as viewers are invited to cast a vote, and for the duration of the voting period, anytime that a user of the DVAESA picks up his telephone to access the system, the system would first respond with the question, “would you like to vote on issue X?” This would be yet another way to derive advertising or promotional revenue from the DVAESA.

There are countless other ways to exploit the architecture of a DVAESA embodying the invention to accomplish tasks and to perform VAs that would have been impossible using the prior art central voice services platforms. The above examples are merely illustrative.

A DVAESA embodying the invention also allows for much greater personalization of the voice applications themselves than was possible with prior art central voice services platforms. In addition, the architecture allows the users themselves to control many aspects of this personalization.

To begin with, as explained above, in a DVAESA a VA Rendering Agent is responsible for customizing voice applications, and then delivering the customized voice applications to the local devices at the customer sites. Thus, the basic architecture assumes that each user will receive and run personalized versions of voice applications. This difference alone makes it much, much easier to provide users with personalized voice applications than prior art central voice services platforms.

The VA Rendering Agent could personalize a voice application to take into account many different things. For instance, the VA Rendering Agent could access a database of user personal information to ensure that a VA takes into account things like the user's name, his sex, age, home city, language and a variety of other personal information. The VA Rendering Agent could also access information about the capabilities of the local device at the customer's location that will be providing the VA, and possibly also the type of audio interface that the user has connected to the local device. The VA Rendering Agent could then ensure that the customized version of the VA that is provided to the user's local device is able to seamlessly and efficiently run on the local hardware and software. The VA Rendering Agent could also take into account user preferences that the user himself has specified. For instance, the VA could be customized to play audio prompts with a certain type of voice specified by the user.

Another important way that VAs could be personalized is by having the DVAESA track how the user is interacting with the system. For Example if the user has a certain type of accent or has a certain pattern of use or has a certain type of background noise, the VA Rendering Agent could take these factors into account on an on going basis to ensure that the customized VAs that are sent to the user are tuned to the user. The system might also note that whenever a three choice menu is played to the user, the user always makes the third selection. In that case, the VA Rendering Agent might be directed to re-render the VA so that the VA presents the third option first, instead of last.

There are any number of other ways that VA's could be customized or personalized to take into account aspects of individual users. And these customizations are easily and automatically accomplished by configuring the VA Rendering Agents to automatically incorporate these personalizations when delivering VAs for users. Because the DVAESA is configured so that each individual user may have his own versions of VAs, preferably stored on his local devices cache, this personalization is not difficult to accomplish. Such personalizations are complimented by the continuous analytics process that is being performed on DVAESA data. This data is collected during the on going functioning of the system and is provided by all DVAESA components. After collection, the data is analyzed, and the results of the analysis are used to continuously tune and improve the functioning of the system on an individual user-by-user basis.

A DVAESA also allows for better, more direct billing for delivery or usage of services. Because there is no telephone company acting as an intermediary, the operator of a DVAESA can directly bill users for use of the system. Also, the way the system is configured, the user can select individual services, which are then provided to him by rendering a VA and loading it on the user's local equipment. Thus, the user can tailor his services to his liking, and the operator of the DVAESA has an easy time tracking what services the user has. For all these reasons, it is much easier to bill the user for use of the services.

Another benefit that flows from the DVAESA model is the ability of a user to access services provided from two different DVAESA operators on a single piece of local equipment. As will be explained in more detail below, a first DVAESA operator could load a first set of VAs onto the user's local equipment, and a second DVAESA operator could load a second set of VAs onto the same piece of operator equipment. For instance, the first DVAESA operator could be one that provides the user with services related to his business, and the second DVAESA operator could be one that provides the user with services relating to the user's personal life. There is no inherent conflict in both having two different sets of VAs loaded onto the local device. And each DVAESA operator can thereafter maintain and update their respective VAs. Likewise, the user can cause both sets of VAs to be loaded on a first device at his office, and a second device at his home. This allows the user to easily and immediately access services from either operator, regardless of his present location. This sort of flexibility would also have been completely impossible in prior art central voice services platforms.

A DVAESA can also provide enhanced security measures compared to prior art central voice services platforms. For instance, because the DVAESA is interacting with the user via spoken commands, it would be possible to verify the identity of a user via a voice print comparison.

In addition, the individual local devices can be identified with unique ID numbers, and credentials verifying the identity and permissions of users and devices can all be created and stored in various locations on the system. By using these unique identification numbers and certification files, one can ensure that only authorized users can access sensitive information or perform sensitive functions.

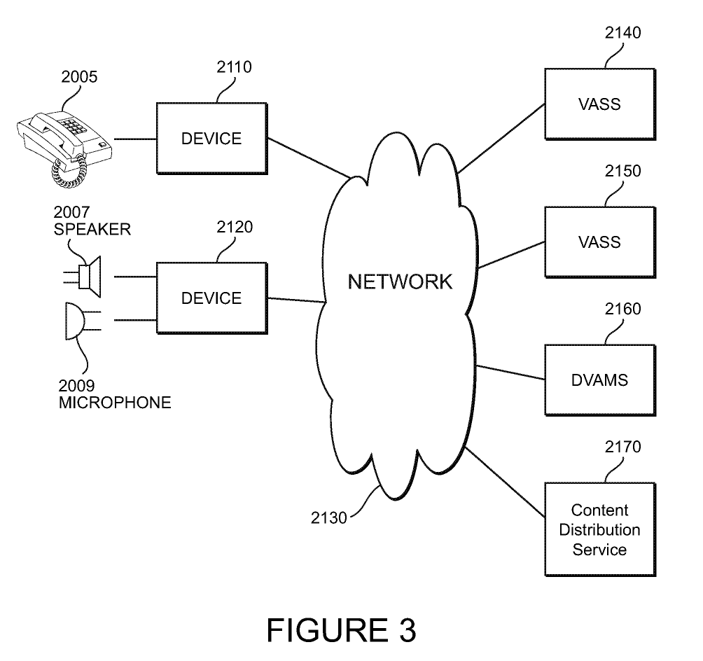

Having now provided a broad overview of the how a system embodying the invention would operate, and the inherent advantages of a DVAESA system as compared to prior art systems, we will now turn to a slightly more specific description of the main elements of a DVAESA embodying the invention, with reference to FIG. 3. In doing so, we will introduce some new definitions and terminology which will be used throughout the remainder of the detailed description.

A DVAESA would be configured to deploy and utilize one or more Voice Application Agents (hereinafter “VAAs”) which themselves enable the delivery or performance of a VA through a local device that would typically be located in a user's home or office. In some instances, a VAA may be wholly resident on a single local device. In other instances, the functions of a VAA may be split between multiple portions of the overall system. Likewise, a single local device may only host one VAA. Alternatively, a single local device may host multiple VAAs. These variations, and the flexibility they provide, will be discussed in more detail below. The important concept is that a VAA is the agent that is responsible for delivering or performing a VA for the user.

The network 2130 shown in FIG. 3 could be the Internet. However, in some instances, the network 2130 could be a public or private local network, a WAN, or a Local Area Network. In most instances, however, the network 2130 will be the Internet. Also, the network 2130 could also comprise portions of the PSTN, existing cellular telephone networks, cable television networks, satellite networks, or any other system that allows data to be communicated between connected assets.

The devices 2110 and 2120 appearing in FIG. 3 would be the local embedded devices that are typically located at a user's home or office. As shown in FIG. 3, in some instances, a local device 2110 could simply be connected to the user's existing telephone. In other instances, the local device could be coupled to a speaker 2007 and microphone 2009 so that the local device can play audio to the user, and receive spoken commands from the user. In still other embodiments, the local device may be a standalone telephone, or be included as part of a cellular telephone, a computing device with wireless access, a PDA that incorporates a cellular telephone, or some other type of mobile device that has access to a data network.

A system embodying the invention also includes components that deliver voice applications, data and other forms of content to the local devices. These components could include one or more Voice Application Services Systems (hereinafter VASSs). In the system depicted in FIG. 3, there are two VASSs 2140 and 2150. A system embodying the invention could have only a single VASS, or could have multiple VASSs.

One of the primary functions of a VASS is to render VAs and to then provide VA components to VAAs. In preferred embodiments, a VASS would provide customized VAs components to VAAs, upon demand, so that the VAAs can perform the customized VAs components for the user. The VASSs could personalize generic VAs based on known individual user characteristics, characteristics of the environment in which the VA components will be performed, information about how a user has previously interacted with the system, and a wide variety factors. The distribution of the personalized VA components to the VAAs could also be accomplished in multiple different ways.

A system embodying the invention may also include one or more Content Distribution Services (hereinafter a “CDSs”). This is an optional component that basically serves as a data storage and content distribution facility. If a system embodying the invention includes one or more CDSs, the CDSs would typically provide network-based caching of content, such as VA components, configurations, DVAESA components, and other shared or frequently used content. The CDSs would be deployed throughout the network to help reduce network traffic latency, which becomes particularly noticeable in any speech interaction system.

The DVAESA components could broadly be identified as a Distributed Voice Application Execution System (hereinafter, a “DVAES”), and a Distributed Voice Application Management System (hereinafter, a “DVAMS”) A DVAES comprises at least a VASS, one or more VAAs, and the underlying hardware and software platforms.

The system shown in FIG. 3 includes a DVAMS. The DVAMS handles a wide variety of management functions which include registering users, specific items of hardware and other DVAES components, directing the rendering, caching, distribution and updating of VAs components, organizing and optimizing the performance of system assets, and multiple other functions. The DVAMS may also include an interface that allows an individual user to customize how the system will interact with him, and what products and services the user wishes to use. The DVAMS would also provide an interface that allows system operators to manually control various aspects of the system.

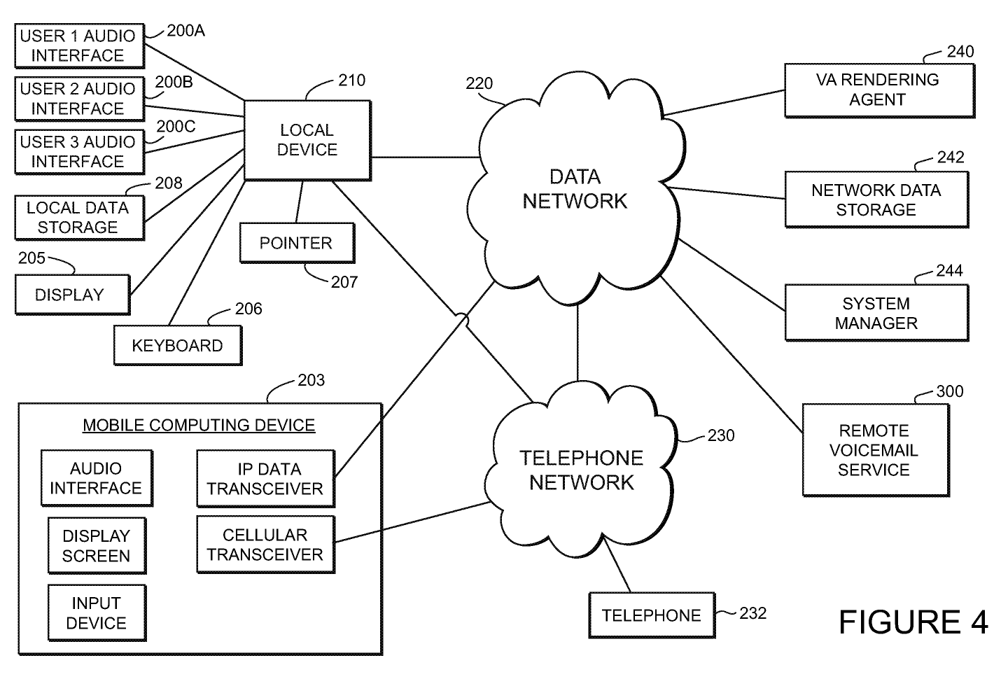

With this background regarding the basic system architecture, we will now turn back to a more detailed explanation of how such a system can deliver enhanced voicemail services to a user. This discussion will initially refer to the system depicted in FIG. 4.

As explained above, it is known to have a voicemail recording device attached to a phone or a PBX so that incoming calls that are not answered by a user are answered by the voicemail recording device. Such systems allow callers to leave recorded messages that can later be retrieved and played by the user. If the user did not want to maintain such equipment in his home or office, the user could rely upon the telephone carrier to route unanswered calls to a third party voicemail service. Typically, the telephone carrier itself furnished the vast majority of such third party voicemail services.

With a system as illustrated in FIG. 4, it is possible to provide voicemail services to a user without the need for a separate voicemail recording device that is connected to the user's phone or PBX, and without the need for the telephone carrier to route an incoming unanswered call to a third party voicemail service.

As explained above, in a system embodying the invention, a local device 210 is present in the user's home or office, or is part of the user's mobile telephone device. The local device 210 would be coupled to one or more audio interfaces. The audio interfaces could User 1's audio interface 200A, User 2's audio interface 200B and User 3's audio interface 200C. Any of these audio interfaces could be a telephone, or an audio interface in the form of a speaker and microphone.

When a caller using telephone 232 dials the user's telephone number, the call will be delivered to the local device 210 via the telephone network 230 and the data network 220. The local device 210 will cause one or more of the audio interfaces 200A-200C to ring. If the user does not pick the call up, a voice application performed on the local device 210 can provide the same sort of voicemail services that were traditionally provided by the telephone carrier or another third party voicemail service. Specifically, the voice application performed on the local device 210 can answer the call and play a pre-recorded greeting message to the caller. The voice application could then record any message that is left by the caller. Further, the voice application, or another related voice application, could then allow the user to retrieve and play voicemail messages that have been left by calling parties.

A voicemail voice application performed on a user's local device could be configured to allow the user to recorded one or more audio messages to be played as greetings when the user fails to answer a call. And the pre-recorded greetings could be stored on the local device 210, on some other device connected to the local device 210, on some remote storage device coupled to the data network 220, or on a remote voicemail service 300 that is accessible over the data network 220. Likewise, messages left by calling parties could be stored on the user's local device 210, on some other device connected to the local device 210, on some remote storage device coupled to the data network 220, or on the remote voicemail service 300.

A user could specify that certain callers should be played a first greeting, and that other callers should be played a second different greeting. Under this scenario, the voicemail voice application performed on the local device 210 would attempt to determine who has placed the incoming call. If the voicemail voice application is able to identify the calling party, the voice application would play the caller the applicable voicemail greeting.

A user could set up many different individually tailored greetings that are to be played to a corresponding number of individuals. For instance, the user could specify that whenever John Smith calls, the local device 210 should play a greeting message that says “Hi John, sorry that I could not take your call, please leave me a message.” With this sort of an arrangement, the user could pre-record a virtually unlimited number of different greetings that are to be played to different individuals.

As noted above, a caller could be identified using the caller ID information. Alternatively, because the local device is capable of providing complex speech recognition functions, the local device could answer the call and ask the caller to identify himself. When the caller speaks his name, the local device could interpret the spoken input, and then compare the interpreted name to names that were specified by the user for certain pre-recorded greetings. If there is a match to a particular pre-recorded greeting, the local device would then play that pre-recorded greeting. If there is no match, the local device could play a default greeting. The speech recognition and name matching that is required to provide these services could be provided by the local device 210, by the remote voicemail service 300, or by a combination of elements that are available to the local device via the data network 220.

The user could also utilize the speech recognition capabilities of the system to help set up the recorded greetings that are to be played to callers. For this reason, when a user is setting up recorded greetings, the user would not even need to know the telephone numbers that are connected with a potential calling party.

For instance, when the user is setting up a personalized voicemail greeting for calls from John Smith, the user could simply speak a voice command indicating that a particular recorded greeting should be used for all calls from John Smith. The local device 210 would then perform speech recognition functions to determine that the user indicated “John Smith.” And the local device 210 could then compare this name to entries in the user's address list to obtain the telephone number for John Smith. In some instances, there might be multiple telephone numbers for John Smith—such as a home number, an office number and a mobile number. The voicemail system would then link the personalized greeting for John Smith to both his name, and all known telephone numbers that are typically used by John Smith. Thereafter, each time that a call is received from any of the telephone numbers used by John Smith, the local device would know to user the recorded greeting specified by the user.

In the example given above, it was assumed that the local device 210 would perform the speech recognition functions required to interpret the user's instructions. In some embodiments, those speech recognition functions could be performed by other elements of the overall system, such as by the remote voicemail service 300.

In addition, the voice application used to set up personalized voicemail greetings could be capable of resolving situations where the user has multiple listings in his address book for the same name. For instance, if the user speaks a command to use a particular recorded voicemail greeting for calls from John Smith, the voice application would then consult the user's address book in an attempt to locate telephone numbers for John Smith. If the voice application finds that there are two separate entries for two different individuals who both have this name, the voice application could then attempt to determine which of the parties the user intended. For instance, the system could ask the user “Do you mean the John Smith who lives on Main Street in Alexandria?” If the user answers “yes,” then the voice application would know to link the personalized voicemail greeting to that John Smith entry. Of course, other similar problems could also be resolved by the voice application by posing additional questions to the user, and by interpreting the user's spoken responses.

It would also be possible for the user to specify that a first greeting be played to callers during certain hours and/or days of the week, and that a second different greeting be played to callers during other hours and/or days of the week. Here again, the user could set up these voicemail preferences using spoken commands. Alternatively, the user could set up the preferences using a display screen 205, a keyboard 206 and/or pointing device 207 coupled to the local device 210, either alone or in combination with spoken commands. In still other instances, the user might access a web page to set up voicemail preferences.

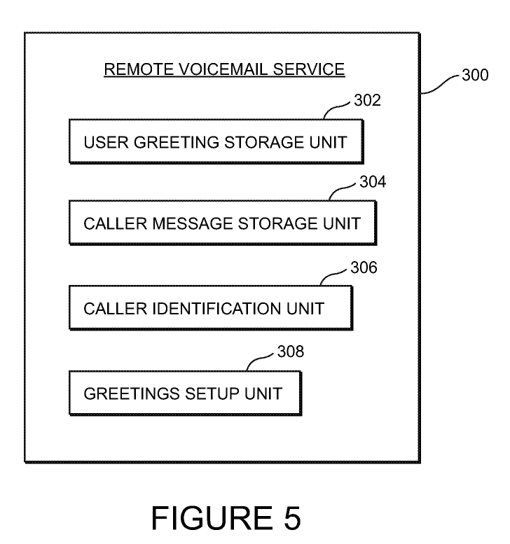

FIG. 5 illustrates the main features of a remote voicemail service 300 which could be used in a system embodying the invention. As shown therein, the remote voicemail service 300 includes a greetings setup unit 308. As discussed above, the greetings set up unit 308 could act in concert with the user's local device to set up a plurality of outgoing personalized voicemail greetings which are to be played to various different potential callers. The greetings set up unit 308 could be utilized by a voice application performed by a user's local device 210 to rapidly record greetings, and to link those personalized greetings to individual potential calling parties. The greetings set up unit 308 could include the speech recognition capabilities that are necessary to interpret a spoken name given by a user, and to match that spoken name to entries in user's address book.

The remote voice mail service 300 could also include a user greeting storage unit 302. The user greeting storage unit 302 could store all of a user's prerecorded outgoing voicemail messages which are to be played to different callers. The user greeting storage unit 302 could also include a matrix of user preferences that determine who should be played each greeting, and whether one greeting should be played during a first time of the day/day of the week whereas a second greeting should be played during a different time of the day/day of the week. Of course, in alternate embodiments, this information could be stored on the local device 210, on a storage device coupled to the local device 210, or on some other remote storage device that is coupled to the data network 220, such as the network data storage 242.

The remote voicemail service 300 could also include a caller message storage unit 304. The caller message storage unit 304 would be used to record messages which are left for a user by calling parties. When user wishes to access and review messages that have been left in his voice message service, a voice application performed on the user's local device could be used to access the messages stored in the caller message storage unit 304 of the remote voicemail service 300. Of course, in alternate embodiments, this information could be stored on the local device 210, on a storage device coupled to the local device 210, or on some other remote storage device that is coupled to the data network 220, such as the network data storage 242.

The remote voicemail service 300 could also include a caller identification unit 306. The caller identification unit 306 would be used to attempt to identify a caller when an incoming telephone call is received by a user's local device.

In many instances, the caller ID information forwarded to the local device 210 as part of the incoming call would allow the caller identification unit 306 to match the incoming call to a personalized voicemail greeting which should be played to that calling party. However, as noted above, not all incoming calls will include caller ID information that lists the telephone number of the calling party.

In those instances, the voice application on the user's local device could ask the calling party to speak his name. The local device could forward a recording of the caller speaking his name to the caller identification unit 306 of the remote voicemail service 300. The caller identification unit 306 could then interpret this spoken input and attempt to match it to one of the personalized greetings stored for this user.

As part of the process of matching the caller's name to a personalized voicemail greeting, the caller identification unit 306 might look at the user's address book to see if there is an entry that matches the caller's name. If so, it might be possible to locate a personalized greeting for the calling party using the telephone numbers provided for the calling party in the user's address book. The use of the caller's telephone numbers for this purpose may be one of the easiest and most certain ways to match a calling party to a pre-recorded personalized voicemail greeting.

In other instances, the caller identification unit 306 might simply try to match the calling party to a personalized greeting based on the name alone. This type of a match might be more difficult or time consuming, and the result might be less certain than in those instances where a telephone number is used to match the calling party to a personalized voicemail greeting. The uncertainty here could result from the inherent uncertainties relating to interpreting the caller's spoken declaration of his name. Nevertheless, this would allow the system to match the calling party to a personalized voicemail greeting even when the calling party is not calling from one of his normally used telephone numbers.

In the foregoing description, it was assumed that the caller identification unit 306 of the remote voicemail service would attempt to match the calling party to a recorded personalized voicemail greeting. In other embodiments, the voicemail voice application being performed on the user's local device 210 could perform these functions. And in still other embodiments, other elements of the overall system that are accessible through the data network 220 could perform these functions. In still other embodiments, a combination of these elements could accomplish there functions.

A system embodying the invention can also provide capabilities that were unavailable on existing voicemail services. For instance, if a user chooses not to answer a call, and the voicemail system answers the call, the user could monitor the call as the caller leaves a message. While this concept is not new, providing this function was impossible if the user made use of a third party voicemail service, as opposed to a separate voicemail recording device connected to the user's telephone. If the user's voicemail service was a service provided by the telephone carrier, as is always the case with a cellular telephone, it was impossible to monitor the call. This also prevented the user from breaking in as the caller is leaving a message to speak to the caller.

In a system as illustrated in FIG. 4, a user's cellular telephone 203 could also act as the local device. As such, a voice application on the cellular telephone 203 could answer a call and play the caller one of the pre-recorded greetings. The user could monitor the call as the caller leaves a voicemail message. And if the user wanted to break in and begin talking to the caller, that is also possible. Thus, a system embodying the invention can provide call monitoring services to users that could not obtain this service with traditional voicemail services.

In addition, in a system embodying the invention, as the caller is leaving a voicemail message, and as the user is monitoring the caller as he leaves a message, the user could instruct the system to play a recorded message to the caller. For instance, if a user monitoring the recordation of a voicemail message determines that a caller is a telemarketer, the user could instruct the system to interrupt the caller and to play the caller a message such as “thank you for your call, but please remove me from your calling list.”

In the scenario discussed above, the user is able to instruct the system to play a caller a pre-recorded message. And the message could be played as the caller attempts to leave a message. However, the system could also operate to play the caller a message at other times. For instance, when an incoming call is received, the voice application on the user's local device would attempt to identify the calling party. As explained above, the caller could be identified based on information in the caller ID, or perhaps based on spoken input provided by the user. The voice application could then inform the user of the identity of the caller. At this point in time, and before the caller is invited to leave a message, the user could instruct the voice application to play a prerecorded audio message to the caller, and to thereafter terminate the call.

In these situations, the caller could have multiple different recordings of messages that could be played to callers. And the user could instruct the system regarding which recorded message the system should play to a caller. a voice application performed on the user's local device could be used to make and store these recordings. In other instances, the remote voicemail service 300 could be used to make and store these recordings. In still other instances, other assets of the system available over the data network 220 could be used to make and store these recordings.

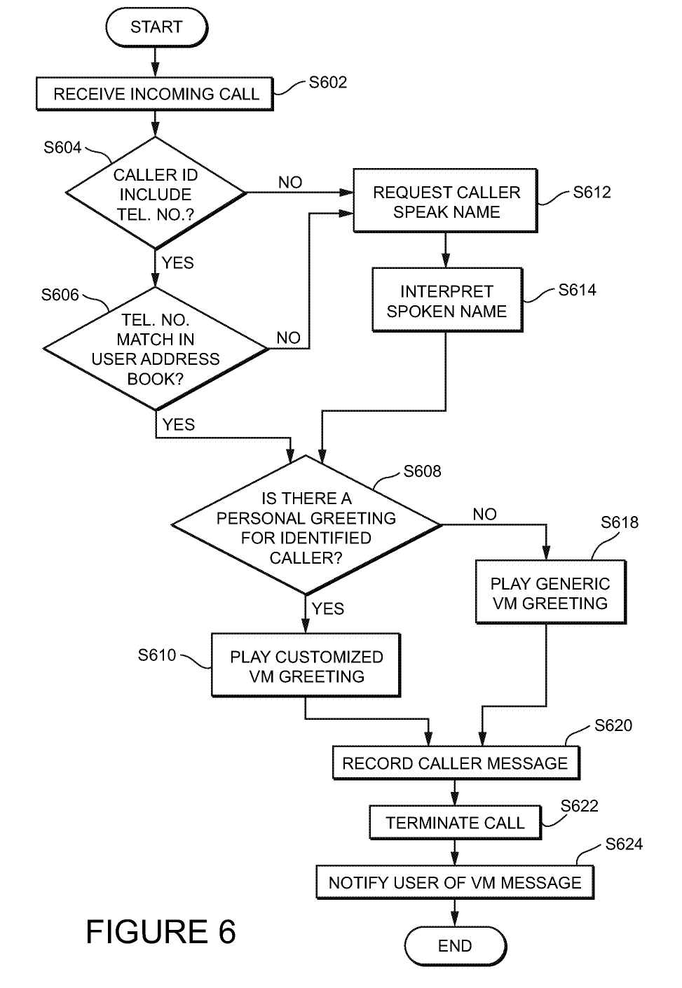

A method embodying the invention which is used to select and play a voicemail greeting to calling parties is illustrated in FIG. 6. The method starts in step S602, when the system receives an incoming call from a calling party.

Assuming the user does not answer the telephone call, the method then proceeds to step S604 where the caller ID information for the incoming call is examined to determine if the telephone number of the calling party has been provided. If the telephone number of the calling party has been provided, in step S606 the system would attempt to match the telephone number of the calling party to a telephone number listed in the user's address book.

If the system finds a match between the telephone number of the calling party, and a telephone number provided in the user's address book, the system will be able to identify the calling party. If the calling party is identified, in step S608 the system determines whether or not there is a personalized greeting tied to this identified caller. If so, in step S610 the system will play the customized voicemail greeting to the calling party.

If the caller ID information for an incoming call does not include the telephone number of the calling party, or if the telephone number provided in a caller ID does not match any of the telephone numbers in the user's address book, then the method would proceed to step S612 where the system would request that the caller speak his name. In step S614 the system would then interpret the spoken name using speech recognition techniques. As noted above, this could occur at the user's local device, or in a remote voicemail service, or using a combination of assets which are available to the local device via the data network 220.

The method would proceed to step S608 where the system would attempt to determine whether a personalized greeting has been set up for the identified calling party. In those situations where a user has been asked to speak his name, this step could include comparing the interpreted spoken name of the calling party to entries in the user's address book to resolve the name to a particular telephone number. In other instances, it may be possible to simply match a name to a personalized voicemail greeting that has been tied to a name.

If the system is unable to determine that there is a personalized greeting for an identified caller, or if a system is unable to actually identify a caller, the system would play a generic voicemail greeting to the calling party in step S618.

Regardless of whether a customized or a generic voicemail greeting was played to the calling party, in step S620 the system would then record the caller's message. In step S622, the system would terminate the call. Finally, in step S624, the system would notify the user that a voicemail message has been received. In some instances, the notification to the user could include identifying the calling party.

Because of the distributed nature of the system, an alert indicating that a voicemail message has been left for a user could be forwarded to all of the local devices which are typically used by the user. In other words, a notification that a voicemail message has been left for the user could be performed by voice applications resident on a user's home local device, the user's office local device, and the user's mobile local device. Providing indications on all local devices that are typically accessed by the user will ensure that the user receives an early notification of the existence of a new voice mail message.

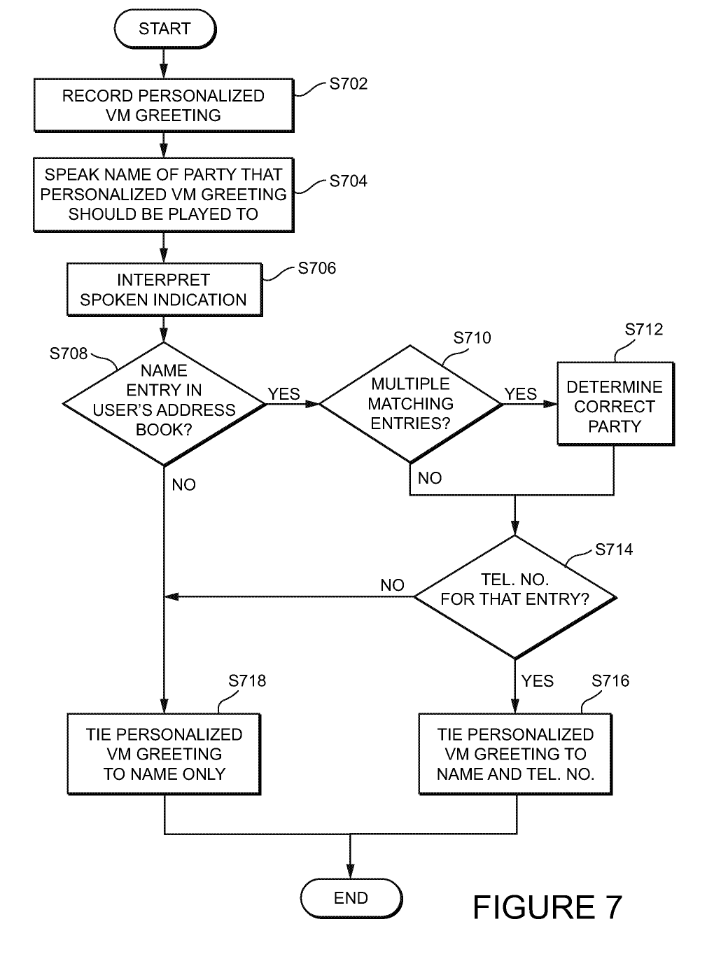

FIG. 7 illustrates steps of a method embodying the invention which can be used to record personalized voicemail greetings and to provide an indication of who the personalized voicemail greetings should be played to. As explained above, the steps of this method could be performed by a voice application performed on a user's local device. In other embodiments, the majority of these method steps could be performed by the greetings setup unit 308 of the remote voicemail service 300. In still other embodiments, the voice application on the user's local device could make use of services and abilities provided by the remote voicemail service, and also by other elements of the system which can help to interpret spoken user commands and to record personalized voicemail greetings.

The method begins in step S703 when a user would record a personalized voicemail greeting. The system would then ask the user for the name of the party or parties that the personalized voicemail greeting should be played to. In step S704, the user would speak the name of at least one party that the personalized voicemail greeting should be played to.

In step S706 the system would interpret the user's spoken input to determine the name that the user has spoken. In step S708, the system would check to determine if there is an entry in the user's address book which corresponds to the name spoken by the user.

If there is an entry in the user's address book which corresponds to the spoken name provided by the user, then in step S710, the system would determine whether or not there are multiple matching entries in the user's address book. If so, the method would proceed to step S712 where the system would determine which of the multiple entries the user intended to indicate. As noted above, this could include the system asking the user about each of the entries in the user's address book to determine which of the entries the user intended to indicate.

The method would proceed to step S714 where the system would check to determine if there is a telephone number in the address book for the identified entry. If so, in step S716 the system would tie the personalized voicemail greeting to both the name and the telephone number of the identified entry in the user's address book. In some instances, a particular party in the user's address book could have multiple telephone numbers. In this case, the personalized voicemail greeting would be tied to each of those numbers.

If the system determines that the name spoken by the user does not correspond to any of the entries in the user's address book (in step S708) or if the system determines that there is no telephone number in the identified entry in a user's telephone book (in step S714) then the method would tie the personalized voicemail greeting to only the spoken name in step S718. The method would then end.

With a method as described above, the system is able to tie personalized voicemail greetings recorded by the user to a name and/or telephone numbers. In some embodiments of the invention, when an incoming call is received, and the telephone number of the calling party is known, the system would first attempt to match the telephone number of the calling party to a personalized greeting. Telephone numbers would be used first to match to a personalized greeting because the match could be made more rapidly and with greater certainty than when the system is attempting to match a name to a personalized greeting.

If there is no telephone number available for the incoming call, or if there is no match for the telephone number of the calling party, the system could then try to match the name of the calling party to a personalized voicemail greeting. The name might have been provided by the caller ID service, or the system might ask the calling party to speak his name and the spoken name could be interpreted. Either way, if the name of the calling party matches a personalized voicemail greeting, that personalized greeting would then be played. The use of the caller's name to identify a personalized voicemail greeting would be used second because of the greater difficulty in making a match this way, and because there may be a lower level of certainty when making a match in this fashion.

If the system is unable to make any match to a personalized greeting, the system would simply play a generic voicemail greeting.

A system embodying the invention can also be used as an interface to retrieve and listen to voicemail messages that have been left for a user on an external system or independent voicemail system operated by a third party. For instance, if a user has his telephone service provided by a typical telephone carrier, the user would also likely have a voicemail service provided by that telephone carrier. With prior art systems, if a user wishes to retrieve and listen to his messages, he must place a telephone call to the carrier's voicemail system, and they typically enter a password to access his voicemail messages.

With a system embodying the invention, a user could interact with a voice application being performed on a local device to access and retrieve messages from a third party voicemail system. In this instance, the voice application could obtain access to the third party's voicemail system directly through the data network. For this reason, it would no longer be necessary for the user to place a telephone call to retrieve voicemail messages.

Likewise, if a user is interacting with a voice application, and the user has already been identified by the system through a password or perhaps through a voiceprint analysis, it might be unnecessary for the user to enter a password to access his voicemail messages from the third party system. Instead, the voice application that interacts with the third party voicemail system could provide all of the user's identification codes so that the user can launch straight into the voicemail messages.

In some instances, the voice application could simply connect the user to a third party voicemail service, typically through a VoIP call. In other instances, the voice application performed for the user could act as the primary interface to allow the user to retrieve and play voicemail messages stored on the third party system. If this is the case, then the user might be able to access and play voicemail messages stored on the third party system using voice commands that are interpreted by the voice application performed on the user's local device.

If a user has a voice application that is capable of accessing voicemail messages stored on other third party systems, that voice application might also be capable of retrieving and playing voicemail messages from multiple third party voicemail systems that are maintained by the user. For instance, the voice application might be able to retrieve and play voicemail messages from a third party voicemail system connected with the user's home telephone number, as well as voicemail messages stored on a third party voicemail system connected with the user's office. And voice commands issued by the user could instruct the voice application were to retrieve the message from.

In a similar fashion, a voice application performed on a user's local device might also be used to retrieve and play information stored on other third party systems. For instance, a voice application performed on a user local device could retrieve e-mail messages from a third party e-mail system. This could include displaying the email messages on a computer or display screen coupled to the user's local device, or even converting the text in an email message into speech, and then playing the audio version of the e-mail for the user.

Likewise, a voice application could retrieve and present or play text or SMS messages stored on a third party system, or instant messages from a third party IM system. Here again, text could be converted to speech by the voice application so that the user could listen to a spoken version of such messages.

A voice application might also be capable of retrieving and displaying or playing text, messages and postings from social networking systems operated by third parties.

Many of the examples given above related to systems and methods for creating personalized voicemail greetings that will be played to callers. However, the system could also be used to create multiple different voice mailboxes, and to direct callers into appropriate ones of those voice mailboxes when they wish to leave a message.

Once a voicemail message has been left for a user, the voice application that was originally used to record the caller's message, or a different voice application, could provide the user with the ability to retrieve and play voicemail messages that have been left by callers.

In some embodiments, the voice application running on the local device 210 could provide all of this functionality. Likewise, any outgoing voicemail greetings played to callers could be stored on the local device 210 or a local storage device 208 coupled to the local device 210. Also, the messages left by callers could be stored on the local device 210 or a local storage device 208 coupled to the local device 210.

In other embodiments, the voicemail greetings and the caller messages could be stored on a remote device, such as a network data storage unit 242 that is available over the data network 220. In still other embodiments, the voicemail greetings and the caller messages could be stored on a remote voicemail service 300 that is also available over the data network 220.

In still other embodiments, although the call would initially be received by a voice application running on a user's local device 210, the functions of answering a call, playing a voicemail greeting, and the function of recording a caller's message could be performed in whole or in part by remote devices, such as the remote voicemail service 300.

With a system embodying the invention, users could set up multiple different voice mailboxes corresponding to multiple different individuals that all utilize the same local device 210. This would be ideal for a situation where multiple individuals all live at the same residence and make use of the same local device 210 at that residence. In many instances, there would be only a single telephone number connected with this location. But callers who have dialed that number, and who interact with a voice application performed on the local device 210, could be routed into different ones of the voice mailboxes established for the users who live at this location. The methods used to direct individual calls into a selected voice mailbox are discussed in more detail below.

Setting up multiple different voice mailboxes that are all connected to a single telephone number and/or a single local device 210 might also be advantageous where multiple individuals work in the same office, and all workers receive incoming telephone calls through the same telephone number and that are received by the same local device 210. Of course, in the case of a business, the local device 210 in the office might also be configured to receive calls placed to multiple different telephone numbers. But regardless of what telephone number a caller dials, once the call is received at the local device 210, the call could be routed into any of the voice mailboxes for any of the individual that work in the office.

In situations where a business maintains a single main telephone number, and callers utilize that telephone number to reach all employees at the business, a voice application performed on the local device 210 might act in a fashion similar to a prior art PBX system to route callers to the appropriate employees. And if an employee does not answer a call, the voice application could route the caller to the employee's voice mailbox. However, as will be explained below, a system embodying the invention can provide voicemail related functions and services that would not have been possible with prior art PBX systems.

In both of the above-described situations, where multiple users share a single local device 210, there might only be a single audio interface, or there might be multiple audio interfaces 200A, 200B and 200C coupled to the local device 210. Where there are multiple audio interfaces, each user could make use of their own dedicated audio interface.

For instance, in a residential setting, there might be one local device 210 in the residence, and there might be only a single telephone number connected with the residence. However, each user at the residence might have his own audio interface. In this instance, when a call is received by the local device 210, a voice application performed by the local device 210 might initially answer the call, and ask the caller to identify the person who the caller is trying to reach. The caller would then state the party he is trying to reach. The system, utilizing its speech recognition capabilities, would then interpret the caller's spoken input, and connect the caller to the appropriate user's audio interface.

If the call is routed to user 1's audio interface 200A, and user 1 does not answer the call, then the voice application running on the local device 210 would route the caller into user l's voice mailbox so that the caller can leave a message for user 1.

In a different but similar situation, there might be no initial answering of the call by a voice application running on the local device 210. Instead, when a caller places a telephone call to the number connected to the residence, the voice application performed on the local device 210 might cause all three of the user audio interfaces 200A, 200B and 200C to ring. Assume that user 3 answers the call using his audio interface 200C. In speaking with the caller, user 3 could learn that the caller wished to reach user 1.

At this point, user 3 could instruct the voice application to re-direct the call to user 1's audio interface 200A. Such an instruction could be a spoken instruction that is interpreted by the voice application performed on the local device 210 using speech recognition techniques. The voice application would then switch the call over to user 1's audio interface 200A, and cause that audio interface 200A to ring. And if user 1 does not answer the call, the voice application could direct the caller into user 1's voice mailbox.

In a similar situation, if user 3 has answered the call and learns that the caller wishes to speak to user 1, and user 3 knows that user 1 is unavailable, then user 3 could instruct the voice application to redirect the caller into user 3's voice mailbox. Here again, this instruction could be provided by user 3 speaking the command, and the voice application on the local device 210 interpreting the command with speech recognition techniques.

In both of the above examples, user 3 would be instructing the voice application being performed on the local device 210 to take some action. The instructions provided to the voice application could be in the form of spoken commands, commands issued by pushing buttons on a keypad of user 3's audio interface, or by combinations of these methods.

In the examples given above, a caller places a telephone call to a residence connected with a single telephone number. In some instances, a voice application might immediately answer the call and interact with the caller to determine who the caller wishes to speak with, and the voice application would then direct the caller to the appropriate user's audio interface. If the user does not answer, then the caller would be placed into that user's voice mailbox.

In other instances, the voice application might not immediately answer the call, and all audio interfaces would ring. In this case, if no user answers the call after a certain period of time has expired, the voice application might then answer the call and interact with the user to determine who the caller was trying to reach. And the voice application could then direct the caller into that user's voice mailbox.

In still other embodiments, when a call come in, the voice application might have standing instructions to ring only some of multiple audio interfaces connected to the local device 210. And these standing instructions, which are what the user specifies when he sets of the system, could vary based on the time of day, and the day of the week. But is no user answers the call, the voice application could then answer the call and interact with the caller to direct the caller into the appropriate voice mailbox.

In the foregoing examples, a single telephone number was connected with the local device 210 that received a call. In other instances, such as in a business setting, the local device 210 might be configured to receive calls directed to multiple different telephone numbers. In this instance, when a call comes in to the local device, the local device would likely know which telephone number was dialed by the caller.

In some situations, each telephone number could correspond to a different user at the location. If that is the case, the voice application performed on the local device 210 would route each incoming telephone call to the user audio interface connected to the dialed telephone number. And if a user does not answer a call, the voice application would connect the caller to that user's voice mailbox.

In other instances, there might be multiple different telephone numbers associated with various users at the location, as well as one or more general telephone numbers for the business. In this instance, the voice application running on the local device 210 could consult standing instructions to determine how to route calls placed to the general telephone numbers. This could involve routing the call to a single user's audio interface, or causing multiple user audio interfaces to ring when a call to a general number is received, and then connecting the call to the audio interface that first answers the call. In still other instances, when a call is received on a general line, the voice application might be configured to answer the call and interact with the caller to determine who the caller is trying to reach. The call would then be routed to the requested user's audio interface.

In those instances where the call was routed to a specific user's audio interface, if the user does not answer, the voice application could route the caller to the user's voice mailbox. If a call to the general telephone number is not answered, the call could be routed to a general voice mailbox associated with the business, or to a default user's voice mailbox. In still other embodiments, if a call to the general number is not answered by a user, the voice application might answer the call and interact with the caller to determine which voice mailbox to which the caller should be routed.

As explained above, multiple different user mailboxes could be reached by calling the same residential or business telephone number. In these instances, a voice application running on a local device is capable of routing a call into the correct voice mailbox. Also, because of the distributed and interconnected nature of the system, the location at which the voice mail messages are actually physically recorded is not important. The voice mail messages could be recorded on the local device 210 that receives the call, a local data storage device 208 coupled to the local device 210, at a remote data storage location 242 or at a remote voicemail service 300.

Two important advantages flow from the nature of this system architecture. First, multiple voice mailboxes can be reached through the same telephone number. As described above, this makes it possible for multiple individuals at a residence/business with only a single telephone number to maintain their own voice mailboxes.

Second, because individual voice mailboxes are no longer tied to individual telephone numbers in a one-to-one relationship, it is also possible for a caller to reach the same mailbox by dialing any one of multiple different telephone numbers.

As explained above, the voice application of the local device that receives a telephone call will ultimately control which voice mailbox a caller is directed into, or the voice application will turn control of the call over to some other system asset that determines which voice mailbox the caller will be directed to. This means that a voice application performed on the user's home local device could direct a caller to the user's business voice mailbox, or that a voice application running on the user's office local device could direct a caller into the user's personal or home voice mailbox. Note, in the first instance, a caller would have dialed the user's residential telephone number, and in the second instance, the caller would have dialed the user's office telephone number.

Because the distributed nature of a system embodying the invention, calls can be routed into particular desired voice mailboxes on a call-by-call basis without any regard for what telephone number was originally dialed. This provides for tremendous flexibility.

In the examples discussed above, it was assumed that each user at a residence would have their own voice mailbox. However, a single user might wish to set up multiple different voice mailboxes. At a minimum, the user would likely wish to have one voice mailbox for personal calls, and another different voice mailbox for business calls. Of course, a user could have any number of different voice mailboxes that have been established for any number of different purposes.

As noted above, regardless of where a call is received, the caller can be directed into any of a user's multiple voice mailboxes. The user can choose, on a call-by-call basis, to which of his voice mailboxes an incoming call should be directed.

For instance, assume that the user establishes one personal voice mailbox and one business voice mailbox. The user could then configure his home local device to send all calls to his residence that are unanswered into his personal voice mailbox. The user could instruct his office local device to send all calls to his office number that are unanswered into his business voice mailbox. However, the user could also change these instructions at any time. Further, the user could instruct the local devices to take a routing action that differs from the standing instruction for one particular call. Or the user could instruct a local device at any location to take a routing action that differs from the standing instructions only for the next hour, and then return to the default routing instructions.

The distributed nature of the system, and the fact that all local devices are coupled to the data network 220, it is possible for a user to provide spoken instructions to a local device in his residence, through an audio interface coupled to the user's home local device, and those instructions could cause the user's office local device to take some routing action that differs from the default routing instructions. For instance, a user could interact with his home local device and instruct his office local device to send all unanswered calls to the user's office telephone number directly into the user's home voice mailbox.

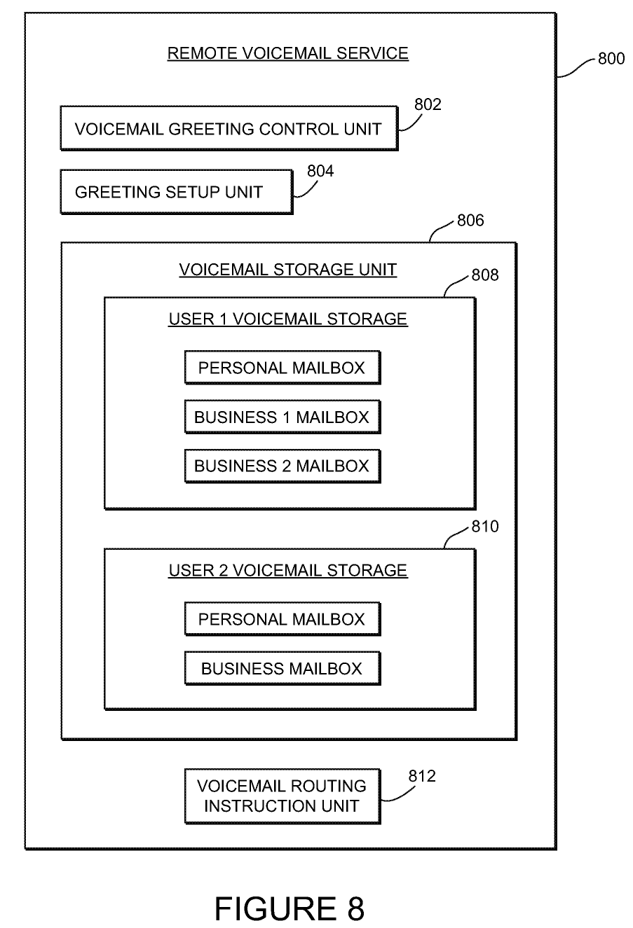

FIG. 8 illustrates another embodiment of a remote voicemail service which could be a part of a system embodying the invention. The remote voicemail service 800 includes a greeting set up unit 804. The greeting set up unit 804 could be used by a person to record one or more voicemail greetings that will be played to callers attempting to reach the user. The user might be able to set up multiple different personalized voicemail greetings which are intended to be used for individual callers or groups of callers. Once individual personalized greetings have been established by the user, when an incoming call is received for the user, a voice application running on a local device receiving the telephone call would check the identity of the calling party. The voice application would attempt to match the identity of the calling party to one of the personalized voicemail greetings previously recorded by the user. If there is a match, the voice application would play the personalized voicemail greeting to the caller. If there is no match, the voice application would play a generic voicemail greeting to the caller.

The remote voicemail service 800 also includes a voicemail greeting control unit 802. The voicemail greeting control unit could be used to determine which personalized voicemail greetings should be played to individual callers based on instructions from the user, and based upon the identity of the calling party. The voicemail greeting control unit 802 could include functionality

The remote voicemail service 800 also includes a voicemail storage unit 806. The voicemail storage unit 806 would include individual voice mailboxes for multiple different users. In the embodiment illustrated in FIG. 8, the voicemail storage unit 806 includes a user 1 voicemail storage area 808, and a user 2 voicemail storage area 810. As illustrated in FIG. 8, user 1's voicemail storage area includes a personal mailbox, a business 1 mailbox, and a business 2 mailbox. User 2's voicemail storage area 810 includes a personal mailbox and a business mailbox. Of course, in an actual embodiment there would likely be a great many different user voicemail storage areas.

With reference to the system illustrated in FIG. 4, the remote voicemail service 800, with the voicemail storage unit 806, could be located remotely from the local devices which directly interact with the users and callers. The remote voicemail service 800 would be accessible via the data network 220.

In other embodiments of the invention, the voicemail storage unit functions could be performed by some other data storage device accessible through the data network such as the network data storage unit 242.

In still other embodiments, the voicemail storage unit functions could be accomplished by storage areas located on a local data storage unit 208 which is directly coupled to a local device 210, or the voicemail storage unit functions could be accomplished on a data storage device which is part of the local device 210 itself.

As explained above, when a caller attempts to reach a user and the user is unavailable, a voice application being performed on a local device that received the call would be capable of directing the caller into any one of multiple voice mailboxes which have been established for the user. In order to determine which voice mailbox the caller should be directed to, the voice application could refer to routing instructions provided by the user.

The remote voicemail service 800 illustrated in FIG. 8 includes a voicemail routing instruction unit 812. The voicemail routing instruction unit 812 would include the voicemail routing instructions set up by each of the individual users. A voice application performed on a local device would consult the voicemail routing instruction unit 812 whenever it requires instructions above how to route a caller into one of the user's voicemail boxes.

The voice mail routing instructions could cause the voice application performed on the local device to route the caller into one voice mailbox during certain times of the day or days of the week, or into a different voice mailbox during other times of the day or days of the week. The user would be able to alter the voicemail routing instructions at will. The instructions could be changed by the user through spoken commands, or possibly through a web interface.

In alternate embodiments of the invention, the voicemail routing instructions could be provided as part of an individual user's voicemail storage unit. Alternatively, the voicemail routing instructions could be stored in other locations such as on the local devices themselves, on alternate remote data storage devices or on local data storage devices which are connected to the local devices 210.

A voicemail system embodying the invention also provides a user with the capability which is not generally possible with any existing voicemail services. Specifically, when a caller attempts to reach a user, and the user actually answers the telephone call and speaks with the caller, it is usually too late to route the caller into a voice mailbox. With existing systems, if the user wishes to route the caller into a voice mailbox, the caller must hang up then redial the user, and the user will then deliberately not answer the call so that the caller would be routed into the user's voicemail box.

With the system embodying the invention, a user could answer a call and speak with a caller, and then instruct the system to route the caller into one of the user's voicemail boxes. For instance, after a caller has been connected with a user and they have spoken with one another, the user can provide a spoken instruction to the voice application performed by the local device which routed the call to the user and instruct the voice application to reroute the caller into one of the user's voicemail boxes. If the user has two or more different voice mailboxes, the user could specify the voice mailbox to which the call is to be directed.

Once a user has answered a call, the user might also be able to issue spoken instructions to the voice application performed on the local device which received the call to instruct that the caller be routed into a voice mailbox associated with a different user. In order to provide this functionality, it may be necessary for one user to grant another user permission to direct calls into his voicemail box. The system could track the authorizations of individual users to ensure that no user improperly directs a caller into another party's voicemail box.

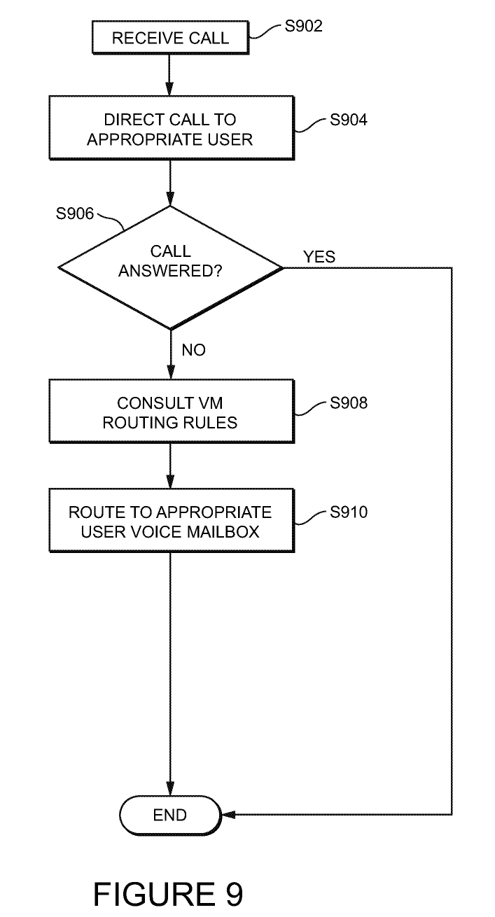

Steps of a method embodying the invention are illustrated in FIG. 9. In this method, a voice application running on a local device would first receive an incoming call from a calling party in step S902. A voice application performed on the local device would determine, in step S904, which user should receive the incoming call. If only one user is connected to a local device, this is a simple decision. In other instances, the voice application running on the local device might need to examine the called telephone number to determine how to route the incoming telephone call. In other instances, the voice application might need to consult routing instructions issued by the users connected with the local device to determine how best to route the telephone call.

In step S906, the voice application would determine whether a user actually answers the incoming telephone call. Typically, this would involve waiting for a predetermined period of time for a user to answer the call. If a user answers the call within that predetermined period of time, the method would end. Alternatively, if the call is not answered by the user within the predetermined period of time, the method would proceed to step S908.

In step S908 the voice application would consult the voicemail routing rules which had been specified by the user to determine whether the user wishes the call to be routed into one of his voice mailboxes. The routing rules could be located on the local device itself, or they could be resident on some other element of the system connected to the local device through a local connection or through the data network 220.

In step S910, the voice application running on the local device would then route the incoming call to the appropriate user voice mailbox. This could include connecting the call to a remote voicemail service reachable through the data network. The method would then end.

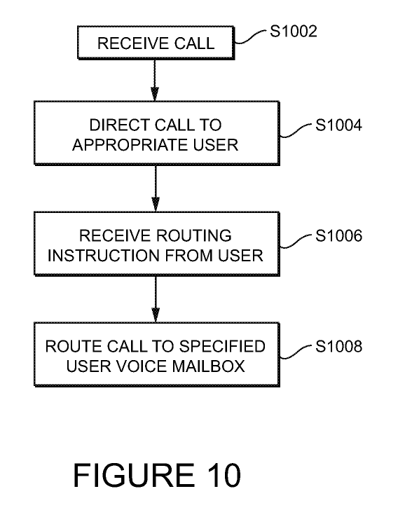

FIG. 10 illustrates steps of another method embodying the invention. In FIG. 10, in step S1002, an incoming telephone call would be received by a voice application running on a local device. In step S1004, the voice application would route the incoming call to the appropriate user. In this method, it is assumed that the incoming call is actually connected to the appropriate user and that the user and the caller begin a telephone call. At some point during that call, in step S1006, the user would issue instructions to the voice application running on the local device which command the voice application to re-route the caller into one of the user's voice mailboxes. In step S1008, the voice application would act to route the caller into the specified user voice mailbox. As explained above, the voice mailbox to which the caller is routed could be a voice mailbox maintained by the user himself, or it could be the voice mailbox of another user. If the user instructs the local device to route the caller into the voice mailbox maintained by a different user, it may be necessary for the voice application to check to determine that the user is authorized to route the caller in this fashion.

Once one or more voice mailboxes have been established for a user, access into the voice mailboxes is controlled so that only authorized individuals can access and play the messages in a voice mailbox. For instance, to access a particular mailbox, a user might need to provide some form of identification and/or a password. Because of the sophisticated speech recognition functions which are possible with a system embodying the invention, the system could prompt the user for such information using an audio prompt, and the user could provide the requested information by speaking a response. Alternatively, the user could enter an identification code and/or a password with a keypad of an audio interface or some other device coupled to the local device. Using a keypad to type in such information might actually be preferable to speaking the information aloud, since it would prevent others within hearing distance from learning a user's password.

In addition, it might be possible for the voicemail system to use a voiceprint analysis to identify a person attempting to gain access to a particular voice mailbox. And the voiceprint verification might be paired with a password to further enhance security.

A voice application performed on a user's local device can also act as an intelligent voicemail message waiting indicator. Rather than simply indicating that there is one or more voicemail messages waiting for the user to review, the voice application would inform the user of who the messages came from. For instance, the voice application could play audio to the user such as “You have one voicemail message from John Smith that was left at 1:30 pm and one voicemail message from Karen Jones that was left yesterday at 9 pm.” The voice application might also indicate that one of the voicemail messages is urgent. And information that the system can gather about voicemail messages that are waiting for review can be summarized and played to the user when the user interacts with the system.

The information used by a voice application to inform the user about details of the voicemail messages could likewise be gathered from third party voicemail systems. Thus, a voice application performed for the user could provide an intelligent voicemail waiting indicator even where the voicemail messages have been left on another party's voicemail system.

In addition, a voice application that is used to access and play voicemail messages could allow the user to review the messages out of the order in which they were recorded. For instance, after learning who has left voicemail messages, the user could request that a voicemail message from a specific party be played first.

A voice application performed for a user could be utilized to establish new voice mailboxes, and to configured the basic set of handling rules that will be used to route voice messages into the new voice mailbox.

In the foregoing discussion, it was assumed that the voicemail greeting played to callers, and the voice messages left by callers were audio recordings. In alternate embodiments, one or both of these types of recordings could be video recordings that include both images and sounds. Also, a user could set up one type of voice mail greeting for a first group of callers as an video voicemail greeting, and a second type of voicemail greeting as an audio-only voicemail greeting. Further, in some embodiments, a voice application that answers a call and allows a calling party to leave a message might give the caller the option of leaving either an audio message or a video message. Systems and methods that include these sorts of audio recordings are also encompassed by the invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although the invention has been described with reference to a number of illustrative embodiments thereof, it should be understood that numerous other modifications and embodiments can be devised by those skilled in the art that will fall within the spirit and scope of the principles of this disclosure. More particularly, reasonable variations and modifications are possible in the component parts and/or arrangements of the subject combination within the scope of the foregoing disclosure, the drawings and the appended claims without departing from the spirit of the invention. In addition to variations and modifications in the component parts and/or arrangements, alternative uses will also be apparent to those skilled in the art.

1. A method of playing personalized voicemail greetings to calling parties, comprising:
determining the identity of a calling party;
determining whether a user has established a personalized voicemail greeting for the calling party;
playing a personalized voicemail greeting to the calling party if a personalized voicemail greeting has been established for the calling party; and
playing a generic voicemail greeting to the calling party if a personalized voicemail greeting has not been established for the calling party.
